(19) United States
(12) Patent Application Publication
(10) Pub. No.: US 2006/0151751 A1
(43) Pub. Date: Jul. 13, 2006

(54) Conductive resin composition, base for photosensitive drum using the composition, and photosensitive drum

(75) Inventors: Munenori Iizuka, Tokyo (JP); Takahiro Suzuki, Tokyo (JP); Kunio Machida, Kunio (JP)

Correspondence Address: SUGHRUE MION, PLLC, 2100 PENNSYLVANIA AVENUE, N.W., SUITE 800, WASHINGTON, DC, 20037, US

(73) Assignee: Bridgestone Corporation, Tokyo (JP)

(21) Appl. No.: 10/540,559

(22) PCT Filed: Dec. 26, 2002
(86) PCT No.: PCT/JP02/13646

§ 371 Date: Jun. 24, 2005

(51) Int. Cl. H01B 1/12

(52) U.S. Cl. 252/500

(57) ABSTRACT

An electrically conductive thermoplastic resin composition to which an electrically conductive agent is added, characterized in that a base resin for the resin composition contains a polyester resin. A resinous base-body for a photosensitive drum made of the above-mentioned electrically conductive resin composition and used in electrostatic recording processes including electro-photographic processes and the like. A photosensitive drum which is made up of the above-mentioned base-body and a photosensitive layer formed thereon. An electrically conductive resin composition which keeps a higher dimensional stability particularly under conditions of high temperature and high humidity without degrading mechanical strength, workability, etc., a base-body for a photosensitive drum using the resin composition, and a photosensitive drum using the base-body become obtainable.

### BACKGROUND OF THE INVENTION

This invention relates to a conductive resin composition, a base for a photosensitive drum using the composition, and the photosensitive drum. Further in detail, this invention relates to an electrically conductive resin composition which is easy to mold and has a higher dimensional stability, a base-body for a photosensitive drum using the composition, and the photosensitive drum using the base-body.

In the conventional electrostatic recording processes employed in electrophotographic or electrostatic recording machines such as a copying machine, a facsimile equipment or printers, an electrostatic latent image is formed by uniformly charging the surface of a photosensitive drum with photoconductive material such as ZnO, CdS, organic photoconductor (OPC), amorphous silicon (a-Si), or the like. Then, a toner image is formed by erasing electrostatic charge of the light-irradiated area irradiated image wisely on the layer from optical system and subsequently supplying a toner on the resultant electrostatic latent image by electrostatic adhesion, and by transferring the resultant toner image to recording media such as paper, photographic paper, etc. or a sheet for an overhead projector, a recorded image is obtained.

In a photosensitive drum employed for the aforementioned electrostatic recording processes, a cylindrical or columnar drum base-body made of aluminum alloy obtained by molding has been conventionally utilized because of lightweight, fine machining capability thereof as well as good electric conductivity. Recently, however, with growing requests for getting much higher productivity and recycling ability, a resinous base-body for a photosensitive drum has been proposed in place of the base-body of an aluminum alloy. The resinous base-body comprises a thermoplastic base resin such as polyamide resin and is produced by injection-molding of an electrically conductive resin composition which is a mixture of the thermoplastic base resin and an electrically conductive agent such as carbon black. The resinous base-body for a photosensitive drum has the following advantages: accessories such as flanges or gears are molded monolithically with the resinous base-body; it runs with lower vibrations and noise; leakage of charge is smaller; potential damping is moderate; recycling ability is improved; and so on.

The above photosensitive drum is required to possess such a performance of having higher dimensional precision in inside and outside diameters, straightness, and roundness, and to keep this performance in a wider range of temperature or humidity under various conditions where the photosensitive drum is used. However, up to now, it has been difficult to obtain a photosensitive drum that fulfills these requirements because the dimensional precision becomes poor particularly under such a driving condition at high temperature and high humidity.

### DISCLOSURE OF THE INVENTION

Under the aforementioned circumstances, the present inventors have addressed the above-mentioned problems. It is an object of the present invention to provide an electrically conductive resin composition which keeps a higher dimensional stability particularly under conditions of high temperature and high humidity without degrading mechanical strength, workability, etc., a base-body for a photosensitive drum using the resin composition, and a photosensitive drum using the base-body.

The present inventors carried out intensive research for developing a resin composition which is used to produce a base-body for a photosensitive drum and the photosensitive drum having aforementioned improved performances. The research has led to the finding that a polyester resin used as a base resin for the resin composition works satisfactorily to obtain improved performances. The present invention is based on this finding.

That is, the present invention provides an electrically conductive thermoplastic resin composition to which an electrically conductive agent is added, characterized in that a base resin for the resin composition contains a polyester resin.

The present invention further provides a resinous base-body for a photosensitive drum made of the above-mentioned electrically conductive resin composition and used in electrostatic recording processes including electrophotographic processes and the like.

The present invention further provides a photosensitive drum which is made up of the above-mentioned base-body and a photosensitive layer formed thereon.

### THE MOST PREFERRED EMBODIMENT TO CARRY OUT THE INVENTION

The electrically conductive resin composition of the present invention is required to have a base resin which contains a polyester resin. When such an electrically conductive resin composition is employed to a base-body for a photosensitive drum, it is possible to produce the base-body by reducing dimensional changes while keeping higher dimensional precision of the base-body.

The base-body for a photosensitive drum of the present invention is produced by injecting or extruding the electrically conductive resin composition into cylinders or cylindrical bodies using the conventional methods. Injection molding is particularly preferred among them.

The above-mentioned polyester resin is preferably the resin which is obtained by reacting aromatic dicarboxylic acids and aliphatic dioxy compounds, including specifically polybutylene terephthalate (PBT), polyethylene terephthalate (PET), polyethylene naphthalate (PEN), polypropylene terephthalate (PPT) or the like. Among them, polybuthylene terephthalate, polyethylene terephthalate, or polyethylene naphthalate is preferable.

Further, in addition to the polyester resin which is used for the base resin of the electrically conductive resin composition, other resins, additives, lubricants, or the like may be admixed, if necessary, so as to improve impact strength, fluidity, workability, etc. Other resins, which are not specifically limited, include a polyamide resin such as nylon-6 or nylon-66 from the viewpoint of improving molding ability and low cost. A less hygroscopic resin is optionally admixed, which includes polypropylene, polyphenylene ether, polyphenylene sulfide, or the like.

The additives are various kinds of elastomers including polyester-based elastomers such as polyester-polyether copolymers, polyolefin-based elastomers such as ethylene-propylene ternary copolymers, and the like; metal soaps such as sodium stearate, sodium montanate, and the like; amide-based lubricants such as stearic acid amide, alkylbisamide, and the like. The elastomers work as an impact improver. The metal soaps, amide-based lubricants, and the like work as an improver for fluidity and workability.

Excessive addition of other resins or additives tends to lower the mechanical properties such as water absorption, chemical resistance, bending elasticity, impact strength or the like, of the resultant electrically conductive resin compositions. The other resins should be admixed in an amount of 100 parts by weight or less, and preferably 30 parts by weight or less, with respect to 100 parts by weight of the polyester resin. The improver for fluidity and workability should be admixed in an amount of 50 parts by weight or less, and preferably 20 parts by weight or less.

The electrically conductive agent admixed with the electrically conductive resin composition of the present invention is not specifically limited, provided that it should be dispersed uniformly in the above-mentioned resin, and includes carbon black, graphite, metal powder of aluminum, copper, nickel, or the like, or electrically conductive glass powder and the like. Among them, carbon black is preferable. The electrically conductive agent is admixed in an amount of preferably 5 to 40 parts by weight, and particularly preferably 20 to 35 parts by weight with respect to 100 parts by weight of the resin. Excess addition of the electrically conductive agent tends to cause degradation of the mechanical properties such as impact strength etc., while smaller addition sometimes causes poor electrical conductivity of the resultant resin composition.

Further, the electrically conductive resin composition of the present invention may optionally contain a filler including various kinds of fiber, whisker, or the like. Specific examples of the filler include an electrically conductive filler such as carbon fiber, electrically conductive whisker, electrically conductive glass fiber, or the like, or a non-conductive filler such as glass fiber, or the like.

In particular, from the viewpoint of emphasizing improvement in elasticity or strength in particular, conventional whiskers or fibers are useful, which include fibrous calcium silicate, potassium titanate, silicon carbide, silicon nitride, magnesium oxide, potassium titanate, aluminum hydroxide, and the like. Among them, fibrous filler, especially whisker of calcium silicate is preferable. Here, the fibrous filler of calcium silicate is available as “Wollastonite” which is produced by pulverizing and purifying natural wollastonite. Wollastonite is given in the form of fine fibrous white powder having an average diameter of 6 to 25 μm.

In addition, in the case of using an inorganic filler among the fillers described above, a good affinity between the inorganic filler and the resin can be obtained by admixing a silane-based or titanate-based coupling agent such as aminosilane, epoxysilane, ureidosilane, vinylsilane, and the like with the resin composition or by treating the surface of the inorganic filler with the coupling agent in advance.

The amount of the filler described above is not specifically limited, and depends on the kinds of fillers or the length or diameter of the fibers. It is preferably 10 to 50 parts by weight with respect to 100 parts by weight of the resin, and particularly preferably 25 to 45 parts by weight. Excess addition of the fillers tends to cause degradation in the mechanical properties of impact strength, while lower addition tends to cause degradation in the mechanical properties such as bending strength, bending elasticity, etc.

The other additives include polytetrafluoroethylene (PTFE), silicone resin, molybdenum disulfide (MOS₂), various kinds of metal soaps, and the like.

The electrically conductive resin composition of the resent invention has the water absorption factor of preferably less than 1.0%, more preferably less than 0.5%, and particularly preferably less than 0.2%. The water absorption factor is measured in accordance with ASTM D-570 when the resin composition is left for 24 hours in an environment of the temperature of 50° C. and the relative humidity of 90%.

Next, the shape of the base-body for a photosensitive drum according to the present invention is preferably cylindrical or columnar because images are developed easily on a recording medium by rotation. The method for molding the base-body is not specifically limited, and includes injection molding, extrusion molding, etc. as described above. Especially, injection molding is preferable among them. The molding conditions such as molding temperature, injection pressure and the like are selected in accordance with the kind etc. of the resin components which form the base-body.

Properties of the outer circumferential surface of the resinous base-body for a photosensitive drum according to the present invention are not specifically limited. However, the surface roughness is preferably 0.8 μm or less, and particularly preferably 0.2 μm or less in terms of the centerline average roughness (Ra); preferably less than 1.6 μm or less, and particularly preferably 0.8 μm or less in terms of the maximum height (Rmax); and preferably 1.6 μm or less, and particularly preferably 0.8 μm or less in terms of the ten-points roughness (Rz). Excessively larger values of these factors of Ra, Rmax, and Rz may sometimes result in the failure of the resultant images because the surface irregularity of the resinous base-body reflects on the photosensitive layer of the photosensitive drum.

The photosensitive drum of the present invention is built in a high-speed image forming apparatus. The photosensitive drum has a photosensitive layer and, if necessary, other layers such as undercoat layers or protective coat layers on the above-mentioned resinous base-body for a photosensitive drum according to the present invention. The photosensitive layer preferably has at least a charge-generating layer and a charge-transporting layer. Here, the charge-generating layer can be composed of, for example, a charge-generating compound and a binder resin. The charge-generating compound is not specifically limited, and is appropriately selected from the publicly known compounds which are conventionally used for a charge-generating layer of photosensitive materials. The publicly known compounds include various kinds of inorganic or organic electrically conductive compounds. Among them, a compound having a higher charge-generating capability is desirable. In addition, the binder resin is not specifically limited, and is appropriately selected from the publicly known resins which are conventionally used for a charge-generating layer of photosensitive materials. The charge-generating layer is formed by known methods of coating, vapor deposition, or the like.

On the other hand, the charge-transporting layer preferably has a heterogeneous charge-transporting layer and a homogeneous charge-transporting layer. The heterogeneous charge-transporting layer is not specifically limited, and a particle dispersing type, a phase separating type, or the like is preferable. The heterogeneous charge-transporting layer is obtained by dispersing in a solvent a material such as a polymer material which is to be incorporated into the heterogeneous charge-transporting layer, followed by forming the resultant dispersion into a layer by a publicly known method such as coating, etc.

The homogeneous charge-transporting layer described above is not specifically limited, but a layer which has a higher charge-transporting capability and a higher film-forming performance is preferable. The homogeneous charge-transporting layer is obtained by dispersing in a solvent a material which is to be incorporated into the homogeneous charge-transporting layer, followed by forming the resultant dispersion into a layer by a publicly known method such as coating, etc.

Next, the present invention will be described in detail with reference to the following examples, which do not limit the scope of the present invention.

### EXAMPLE

The water absorption factor of the resin composition and the change in the external diameter of the base bodies for photosensitive drums were measured in accordance with the following methods:

<Water Absorption Factor>

A sample was left standing for 24 hours in an environment of the temperature of 50° C. and the relative humidity of 90%, and then the water absorption factor was measured in accordance with ASTM D-570.

<Change in the External Diameter of a Base-Body for a Photosensitive Drum>

After measuring the external diameter (A) at an end section of each base-body for a photosensitive drum which was produced in the following examples, the external diameter (B) was measured again after the base-body was left standing for 24 hours in an environment of the temperature of 50° C. and the relative humidity of 90%. The change in the external diameter was obtained by divding the difference of [(B)−(A)] by (A) and was represented in percent.

### Examples 1 to 3 and Comparative examples 1 to 3

By using a polyester resin (Examples) or a polyamide resin (Comparative examples) as a base resin, each electrically conductive resin composition was prepared according to the mixing ratios of the resin compositions given in Table 1 using a twin screw extruder. The water absorption factor (%) was measured in accordance with the method described above. The results are shown in Table 1.

Further, each electrically conductive resin composition was molded by injection molding into a base-body for a photosensitive drum, which had an external diameter of 30 mm, a length of 260 mm, and a peripheral wall thickness of 1.7 mm. The change (%) in the external diameter was measured under the conditions of high temperature and high humidity at 50° C. and 90% relative humidity in accordance with the method described above. The results are shown in Table 1.

TABLE 1

| Mixing ratios of electrically conductive resin compositions | | | | | | Characteristics | |
|---|---|---|---|---|---|---|---|
| | | | | Electrically | | | External diameter |
| | | | | conductive agent | Reinforcing agent | Water absorption | change of |
| Resin (pans by weight) | | | | (parts by weight) | (parts by weight) | factor (%) | base-body for the |
| PA66 | PBT | PET | PEN | Carbon black | Wollastonite | ASTM D-570 | drum (%) |

| | | | | | | | | |
|---|---|---|---|---|---|---|---|---|
| Water absorption factor | 1.8 | 0.08 0.06 | 0.03 | — | — | | | |
| (%) | | | | | | | | |
| ASTM D-570 | | | | | | | | |
| Comparative example 1 | 100 | — | — | — | 30 | 35 | 1.0 | 0.4 |
| Comparative example 2 | 100 | — | — | — | 30 | 25 | 1.4 | 0.6 |
| Comparative example 3 | 100 | — | — | — | 20 | 35 | 1.2 | 0.5 |
| Example 1 | — | 100 | — | — | 30 | 35 | 0.2 | 0.04 |
| Example 2 | — | — | 100 | — | 30 | 35 | 0.18 | 0.03 |
| Example 3 | — | — | — | 100 | 30 | 35 | 0.14 | 0.02 |

Note:
PA66: Nylon 66, “UBE nylon” ™ manufactured by UBE INDUSTRIES, LTD.
PBT: Polybutylene terephthalate, “TEIJIN PBT” ™ manufactured by WINTECH POLYMER LTD.
PET: Polyethylene terephthalate, “DIANITE” ™ manufactured by MITSUBISHI RAYON CO., LTD.
PEN: Polyethylene naphthalate, “PEN Resin” ™ manufactured by TEIJIN LIMITED.
Carbon black: furnace carbon black, “Asahi AX-015” ™ manufactured by ASAHI CARBON CO., LTD.
Wollastonite: “Wollastonite” ™ manufactured by KAWATETSU MINING COMPANY, LTD.

The results given in Table 1 show that the water absorption factor of the electrically conductive resin compositions prepared in Examples 1 to 3 using the polyester resin is substantially smaller than that of the electrically conductive resin compositions prepared in Comparative examples 1 to 3 using the polyamide resin. Further, the change in the external diameter of the base bodies for photosensitive drums prepared in Examples is also much smaller, by a factor of 10 or more, than that of the base bodies prepared in Comparative examples, showing that all of the base bodies prepared in Examples according to the present invention have excellent dimensional precision under the conditions of high temperature and high humidity.

### INDUSTRIAL APPLICABILITY

According to the present invention, an electrically conductive resin composition having an excellent dimensional stability can be provided. Consequently, it is possible to obtain, by achieving weight reduction easily without degrading mechanical strength, workability, dimensional precision, etc., a base-body for a photosensitive drum consistently, which also can maintain an excellent dimensional precision even under a service condition in particular of high temperature and high humidity. In addition, the outbreak of failures in images is suppressed effectively by applying the base-body to a photosensitive drum.

1. An electrically conductive thermoplastic resin composition to which an electrically conductive agent is added, characterized in that a base resin contains a polyester resin.

2. The electrically conductive resin composition according to claim 1, wherein the electrically conductive resin composition has the water absorption factor of less than 1.0% which is measured in conformity with ASTM D-570 when the composition is left standing for 24 hours in an environment of the temperature of 50° C. and the relative humidity of 90%.

3. The electrically conductive resin composition according to claim 1, wherein the polyester resin is polybutylene terephthalate, polyethylene terephthalate, or polyethylene naphthalate.

4. The electrically conductive resin composition according to claim 1, wherein the electrically conductive resin composition further contains a filler.

5. The electrically conductive resin composition according to claim 4, wherein the amount of the filler admixed is 10 to 50 parts by weight with respect to 100 parts by weight of the resin.

6. The electrically conductive resin composition according to claim 4, wherein the filler is fibrous calcium silicate.

7. A resinous base-body for a photosensitive drum used in electrostatic recording processes, wherein the resinous base-body is made of the electrically conductive resin composition according to claim 1.

8. A photoconductive drum comprising a photoconductive layer on the resinous base-body for the photosensitive drum according to claim 7.
